(19) United States
(12) Patent Application Publication
(10) Pub. No.: US 2010/0114760 A1
(43) Pub. Date: May 6, 2010

(54) ONLINE INTERACTIVE ISSUED ACCOUNT ACQUIRED TRANSACTION INFORMATION MANAGEMENT

(76) Inventors: Raj Sundarasen, Foster City, CA (US); Ramki Rosanuru, Cedar Park, TX (US); Srini Reddi, Fremont, CA (US); Sharon North, San Carlos, CA (US); Heide Ulrich, Half Moon Bay, CA (US); Peter Ciurea, Orinda, CA (US); Karteek Patel, San Francisco, CA (US); Sarah Suarez, South San Francisco, CA (US); Alistair Duncan, Danville, CA (US); Pat Stan, Pacifica, CA (US); Tim Ural, Mill Valley, CA (US)

Correspondence Address: Quarles & Brady LLP, TWO NORTH CENTRAL AVENUE, One Renaissance Square, PHOENIX, AZ, 85004-2391, US

(21) Appl. No.: 12/534,800

(22) Filed: Aug. 3, 2009

Related U.S. Application Data
(60) Provisional application No. 61/086,140, filed on Aug. 4, 2008.

(51) Int. Cl. G06Q 20/00; G06Q 40/00

(52) U.S. Cl. 705/39

(57) ABSTRACT

A single point of access and an integrated user experience for a set of tools are provided for a payment processing system that includes a transaction handler in communication with issuers and acquirers for the processing of payments from the issuers to the acquirers. The tools include: (i) commercial reporting; (ii) expense management; and (iii) account program management tools that are used by (a) issuers who issue the accounts for the cards to account holders and by (b) the account holders. Multiples services are integrated as relevant to specific audiences through an entitlement process, where a single point access is allowed. Applications, which can be developed and/or hosted independently, are accessible through a common interface.

### CROSS NOTING

This application claims priority to U.S. Provisional Application Ser. No. 61/086,140, filed on Aug. 4, 2008, titled Online Interactive Issued Account Acquired Transaction Information Management, which is incorporated herein by reference.

### FIELD

The invention is related to a payment processing system in which a transaction between a merchant and a consumer conducted on an account issued by an issuer, where the transaction is acquired from the merchant by an acquirer for collection on the account from the issuer through a transaction handler or transaction processor. The invention is more particularly related to online interactive access and management of information from the payment processing system.

### BACKGROUND

In working with data in a payment processing system, a persistent inconvenience is that there is no single point of access or an integrated user experience for (i) commercial reporting; (ii) expense management; and (iii) account program management tools that are used by (a) issuers who issue the accounts for the cards to account holders and by (b) the account holders.

### SUMMARY

The invention provides a single point of access and integrated user experience, in a payment processing system, for a set of tools, including: (i) commercial reporting; (ii) expense management; and (iii) account program management tools that are used by (a) issuers who issue the accounts for the cards to account holders and by (b) the account holders. The invention integrates multiples services as relevant to specific audiences through an entitlement process, where a single point access is allowed. Applications, which can be developed and/or hosted independently, are accessible through a common interlace.

In one implementation, an electronic message is received through a single logical point of access in a telecommunications network. The received electronic message contains an identifier for an account used to conduct a transaction in a payment processing system. The received electronic message is received from a logical address associated with a recipient in the payment processing system. The recipient can be an issuer of the account to the account holder, an acquirer for a merchant with whom the transaction was conducted on the account, the account holder, or a transaction handler who processes the issuer's payment for the transaction for delivery to the acquirer for the merchants. The single logical point of access is in communication with each of the issuer, the merchant's acquirer, the account holder, and the transaction handler. Data is retrieved, from a database, as corresponds to the account used to conduct the transaction in the payment processing system. An electronic message is sent from the single logical point of access in the telecommunications network. The sent electronic message contains the data retrieved from the database. The sent electronic message is sent to a logical address associated with a recipient in the payment processing system that is selected from the group consisting of the issuer of the account to the account holder, the acquirer for the merchant with whom the transaction was conducted on the account, the account holder, and the transaction handler who processes the issuer's payment for the transaction for delivery to the acquirer for the merchant.

### BRIEF DESCRIPTION OF THE DRAWINGS

FIG. 1 depicts an exemplary process for an exemplary payment processing system;

FIG. 2 is a flow chart of a process of exemplary transactions within the payment processing system of FIG. 1;

FIG. 3 is a block level diagram that depicts an exemplary system in which a host 412 sells a subscription to issuers and each account holder has online, real time, interactive access to data accumulated and mined by a transaction handler of FIG. 1.

FIG. 4 depicts an exemplary process for of a particular financial transaction system in which there is a provision of a service by a merchant to a consumer in authorizing and remunerating electronic payment by an account holder in conducting a financial transaction with a merchant (i.e.; a credit card transaction).

FIG. 5 illustrates systems housed within an interchange center to provide online and offline transaction processing; and

FIG. 6 illustrates another view of the components of FIG. 4.

Implementations will become more apparent from the detailed description set forth below when taken in conjunction with the drawings, in which like elements bear like reference numerals.

### DESCRIPTION

### Payment Processing System

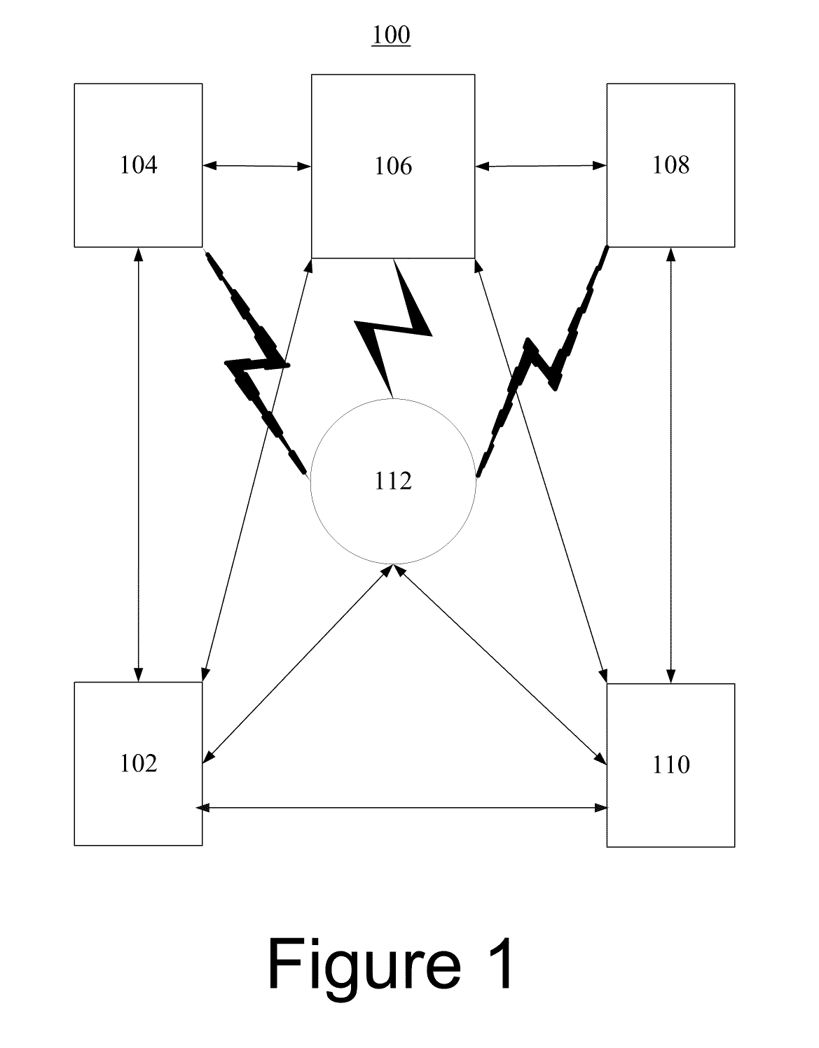

The Payment System illustrated in FIG. 1 depicts an exemplary process which can be used by the foregoing Implementations with respective modifications as described therein.

A transaction includes participation from different entities that are a component of a payment processing system 100 including an issuer 102, a transaction handler 104, such as a credit card company, an acquirer 106, a merchant 108, or a user 110 such as an account holder and/or consumer. The acquirer 106 and the issuer 102 can communicate through the transaction handler 104. Merchant 108 will be a person or entity that sells goods or services, and will more preferably be one or more transit systems as described in the above implementations. Merchant 108 include, for instance, a bus company, a subway system, a light rail system, a private or municipal transit system, and the like. Merchant 108 may utilize at least one Point-of-Service (POS) terminal that can communicate with the acquirer 106, the transaction handler 104, or the issuer 102. Thus, the POS terminal is in operative communication with the payment processing system 100. The POS terminal may be at a turnstile of a subway, entry or exit point, on a commuter train or terminal thereof, on a light rail train or terminal thereof, on a city bus or terminal thereof, on a water taxi or terminal thereof, and the like.

Typically, a transaction begins with the user 110, such as an account holder or a consumer, presenting a Consumer Portable Transaction Payment Device (CPTPD) 112 to merchant 108 to initiate an exchange for a good or service. The CPTPD 112 may include a volatile or non-volatile memory to store information such as the account number or an account holder's name.

Merchant 108 may use the POS terminal to obtain account information, such as an account number, from the portable consumer device. The CPTPD 112 may interface with the POS terminal using a mechanism that may include a contactless system using a radio frequency and/or magnetic field recognition system, but may additionally be adapted for use in a contact system such as by a magnetic stripe reader. The POS terminal sends a transaction authorization request to the issuer 102 of the portable consumer device. Alternatively, or in combination, the CPTPD 112 may communicate with the issuer 102, the transaction handler 104, or the acquirer 106.

The issuer 102 may authorize the transaction using the transaction handler 104. The transaction handler 104 may also clear the transaction. Authorization includes the issuer 102, or the transaction handler 104 on behalf of the issuer 102, authorizing the transaction in connection with the issuer's 102 instructions such as through the use of business rules. The business rules could include instructions or guidelines from the transaction handler 104, the user 110, merchant 108, the acquirer 106, the issuer 102, a financial institution, or combinations thereof. The transaction handler 104 may maintain a log or history of authorized transactions. Once approved, merchant 108 will record the authorization, allowing the user 110 to receive the good or service.

Merchant 108 may, at discrete periods, such as the end of the day, submit a list of authorized transactions to the acquirer 106 or other components of the payment processing system 100. The transaction handler 104 may compare the submitted authorized transaction list with its own log of authorized transactions. If a match is found, the transaction handler 104 may route authorization transaction amount requests from the corresponding acquirer 106 to the corresponding issuer 102 involved in each transaction. Once the acquirer 106 receives the payment of the authorized transaction amount from the issuer 102, it can forward the payment to merchant 108 less any transaction costs, such as fees. If the transaction involves a debit or pre-paid card, the acquirer 106 may choose not to wait for the initial payment prior to paying the merchant 108.

There may be intermittent steps in the foregoing process, some of which may occur simultaneously. For example, the acquirer 106 can initiate the clearing and settling process, which can result in payment to the acquirer 106 for the amount of the transaction. The acquirer 106 may request from the transaction handler 104 that the transaction be cleared and settled. Clearing includes the exchange of financial information between the issuer 102 and the acquirer 106 and settlement includes the exchange of funds. The transaction handler 104 can provide services in connection with settlement of the transaction. The settlement of a transaction includes depositing an amount of the transaction settlement from a settlement house, such as a settlement bank, which the transaction handler 104 typically chooses, into a clearinghouse, such as a clearing bank, that the acquirer 106 typically chooses. The issuer 102 deposits the same from a clearinghouse, such as a clearing bank, which the issuer 102 typically chooses into the settlement house. Thus, a typical transaction involves various entities to request, authorize, and fulfill processing the transaction.

Various terms may be used herein, which are to be understood according to the following descriptions 1 through 8:

1. Acceptance point device includes a device capable of communicating with a payment device, where the acceptance point device can include a Point of Device (POS) device, a smartcard, a payment card such as a credit or debit card with a magnetic strip and without a microprocessor, a keychain device such as the SPEEDPASS® commercially available from ExxonMobil® Corporation, a cellular phone, personal digital assistant (PDA), a pager, a security card, an access card, a smart media, a transponder, personal computer (PC), tablet PC, handheld specialized reader, set-top box, electronic cash register (ECR), automated teller machine (ATM), virtual cash register (VCR), kiosk, security system, or access system;

2. Account holder or user includes any person or entity with an account and/or a payment device associated with an account, where the account is within a payment system;

3. Issuer includes any entity that issues one or more accounts and/or payment devices;

4. Merchant includes any entity that supports an acceptance point device;

5. Participant includes any user, person, entity, charitable organization, machine, hardware, software, merchant or business who accesses and uses the system of the invention, such as any consumer (such as primary member and supplementary member of an aggregate consumer account), retailer, manufacturer, and third-party provider, and any subset, group or combination thereof;

6. Redemption includes obtaining a reward using any portion of points, coupons, cash, foreign currency, gift, negotiable instruments, or securities;

7. Reward includes any discount, credit, good, service, package, event, experience (such as wine tasting, dining, travel), or any other item; and

8. Payment device includes a card, smartcard, ordinary credit or debit cards (with a magnetic strip and without a microprocessor), a keychain device (such as the SPEEDPASS™ commercially available from Exxon-Mobil Corporation), cellular phone, personal digital assistant (PDA), pager, payment card, security card, access card, smart media, or transponder, where each payment device can include a loyalty module with a computer chip with dedicated hardware, software, embedded software, or any combination thereof that is used to perform actions associated with a loyalty program.

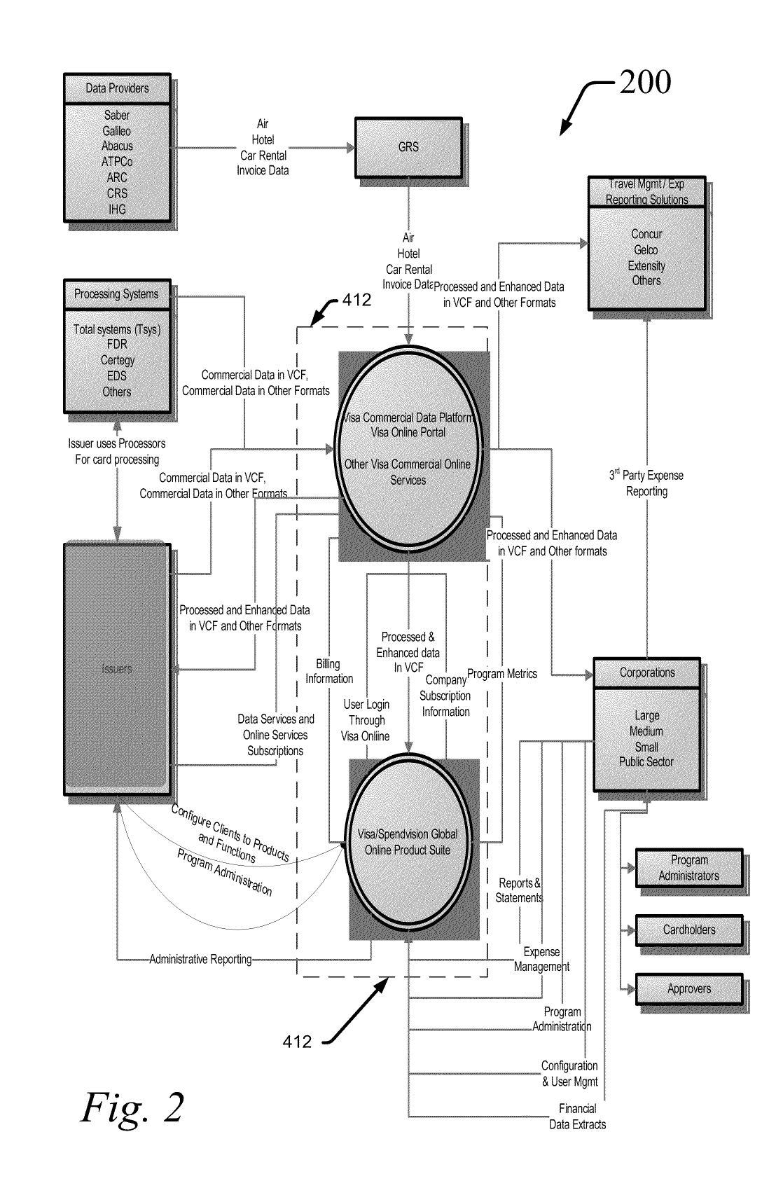

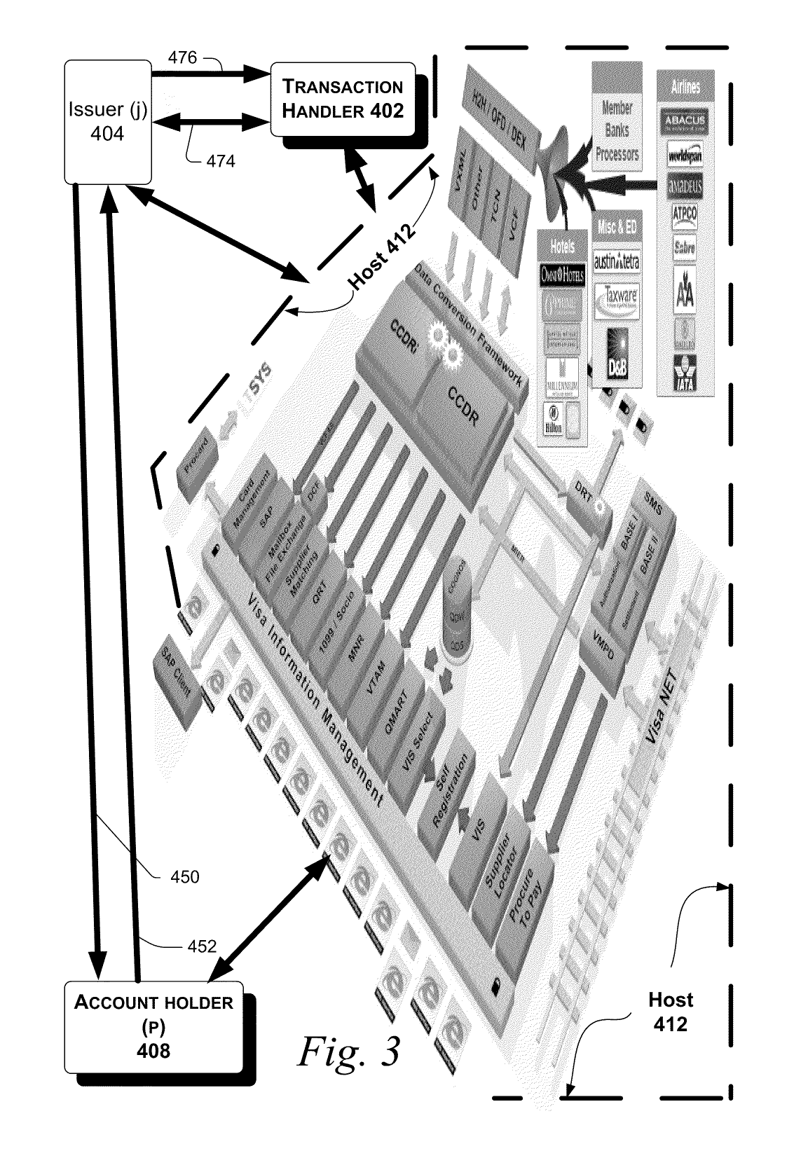

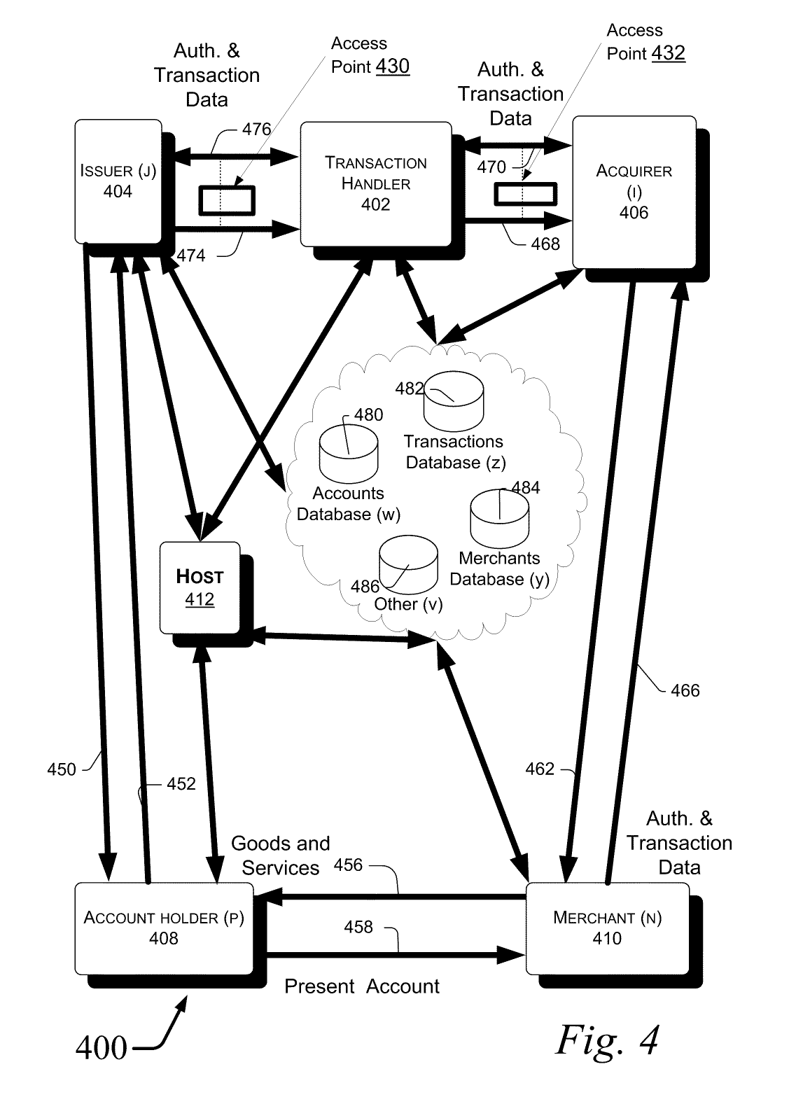

FIG. 2 is a flow chart of a process 200 of exemplary transactions within the payment processing system of FIG. 1, as well as exemplary funds flow of such exemplary transactions. In process 200, indicia marked as “Visa” is intended to represent the transaction handler 104 seen in FIG. 1. A host 412 seen in FIGS. 2-4 is intended to represent a service provider of online, real time, interactive access to data accumulated and mined by the transaction handler 104 of the payment processing system seen in FIG. 1. This online access in process 200 can be provided as a subscription to each user 110 of each issuer 102 seen in FIG. 1, to issuers 102 seen in FIG. 1, to issuers 404 seen in FIGS. 2-4, and to account holders 408 seen in FIGS. 3-4. Other boxes and ovals seen in FIG. 2 are labeled as to functions common in contemporary payment processing systems, including the processing of payments within the travel and entertainment industries, with connecting arrows as to flows there between. Optionally, one or both of the ovals labeled in FIG. 2 with the indicia “Host 412” can be the third party access provider for the transaction handler 104, where the transaction handler 104 in FIG. 2 is labeled as “Visa”. FIG. 2 shows the following functions Chargeback Reduction Service (CRS), Global Resource Serialization (GRS),

FIG. 3 is a block level diagram that depicts an exemplary system in which the host 412 is sells a subscription to each issuer (j) 404 and each account holder (p) 408 thereof to have online, real time, interactive access to data accumulated and mined by the transaction handler 104 of the payment processing system seen in FIG. 1. The data accumulated and mined is represented within the box delimited by a broken line labeled “host 412”. Online access for process 200 seen in FIG. 2 can be provided through each such subscription in the system seen in FIG. 3, where the transaction handler 402 of FIG. 3, and also labeled “Visa” in FIG. 3, facilitates accumulation and mining of data from the exemplary payment processing systems seen in FIGS. 1 and 4, to each user 110 of each issuer 102 seen in FIG. 1, to issuers 102 seen in FIG. 1, to issuers 404 seen in FIGS. 2-4, and to account holders 408 seen in FIGS. 3-4. Other boxes and ovals seen in FIG. 2 are labeled as to functions common in contemporary payment processing systems, including the processing of payments within the travel and entertainment industries, with connecting arrows as to flows there between. Optionally, one or both of the ovals labeled in FIG. 2 with the indicia “Host 412” can be the third party access provider for the transaction handler 104, where the transaction handler 104 in FIG. 2 is labeled as “Visa”.

Five (5) commercial online reporting applications are seen in the illustrated key transaction diagram and funds flows of FIG. 3: VIS, VISS, MNR, VTAM and 1099. Each Issuer (j) 404 and account holder (p) 408 thereof, can be managed via a Visa Flexible Access Control (FAC) service. Also seen in FIG. 2 are the following functions: Visa Travel Account Manager (VTAM); Authorization Center Identification Number [BASE 1] (ACIN); Single-Message System (SMS); Commercial Center Data Repository (CCDR); Open File Delivery (OFD); Direct Exchange (DEX).

The information accumulated and mined by the transaction handler in a payment processing system can be accessed through the host so as to be accessible via a single on-line access portal to issuers and their account holders. Services that can be offered include multiple language communication (i.e., Mandarin communication and characters), dual currency statements, the offering of alerts on metrics that approach a limit, a snapshot of a global market in which a merchant in the market has corresponding local (i.e., national) metrics that are rolled up into a global metric (important because different national offices may use different accounting protocols, pay different taxes, or have different implementations based on local strategy).

The single point of access and integrated user experience can be offered via that host for a set of commercial reporting, expense management and card program management tools used by commercial issuers and their client (cardholders). These integrated multiple services can be designed so as to be are relevant to specific audiences through an entitlement process.

FIG. 4 depicts an exemplary process for the provision of a service by a merchant to a consumer in authorizing and remunerating electronic payment by a account holder (p) 408 in conducting a financial transaction with the merchant (i.e.; a credit card transaction). The diagram of FIG. 4 depicts an exemplary process 400 of a particular financial transaction system. By way of explanation for the nomenclature of reference numerals used in the Figures and described in the specification, a lower case letter in parenthesis is intended to mean an integer variable having a value from 1 to the capital case of the lower case letter, which value can be large (i.e., approaching infinity). Thus ‘(b)’ is intended to mean that the integer ‘b’ can have a value from 1 to B, and ‘(c)’ is intended to mean that the integer ‘c’ can have a value from 1 to C, etc. As such, drawing elements 404, 406, 408, 410, 480, 482, and 484 in FIG. 4 are illustrated with a block, but indicate one or more elements can be present. For example, Issuer (j) 404 is one of a possible plurality of issuers, where j may range from 1 to a large integer.

Account holder (p) 408 presents an electronic payment device (i.e.; a credit card) to a Merchant (n) 410 (at step 458) as tender for a financial transaction such as a purchase of goods. Those of skill in the art will recognize that other financial transactions and instruments other than credit cards may also be used, including, but not limited to, a prepaid card and a debit card. For purposes of illustration and explanation, however, reference will be made to a credit card.

As part of the transaction, the Account holder's 408 payment device can be a credit card, debit card, prepaid card, cellular telephone, Personal Digital Assistant (PDA), etc. The payment device is read by a reader operated by the merchant (n) 410, whereupon account information is read from the payment device and a request for authorization is transmitted to the Merchant's 410 Acquirer (i) 406 (at step 462). Each Acquirer (i) 406 is a financial organization that processes credit card transactions for businesses, for example merchants, and is licensed as a member of a transaction handler 402 such as a credit card association (i.e. Visa Inc. MasterCard, etc.) As such, each Acquirer (i) 406 establishes a financial relationship with one or more Merchants (n) 410.

The Acquirer (i) 406 transmits the account information to the TH 402 (at step 470), who in turn routes the request to the account holder's issuing bank, or Issuer (j) 404 (at step 476). The Issuer (j) 404 returns authorization information to the TH 402 (at step 474) who returns the information to the Merchant (n) 410 through the Acquirer (i) 406 (by steps 468 and 466). The Merchant (n) 410 now knowing whether the Issuer's (j) 404 credit card account is valid and supports a sufficient credit balance, may complete the transaction and the Account holder (p) 408 in turn receives goods and/or services in exchange (at step 456). Most credit card associations instruct merchants that, after receiving authorization, the detailed credit card account information obtained from the point of sale magnetic stripe scanner must be deleted.

To reconcile the financial transactions and provide for remuneration, information about the transaction is provided by the Merchant (n) 410 to Acquirer (i) 406 (at step 462), who in turn routes the transaction data to the TH 402 (at step 470) who then provides the transaction data to the appropriate Issuer (j) 404 (at step 476). The Issuer (j) 404 then provides funding for the transaction to the TH 402 (at step 474) through a settlement bank (not shown). The funds are then forwarded to the Merchant's (n) 410 Acquirer (i) 406 (at step 468) who in turn pays the Merchant (n) 410 for the transaction conducted at step 462 less a merchant discount, if applicable. The Issuer (j) 404, then bills the Account holder (p) 408 (at step 450), and the Account holder (p) 408 pays the Issuer 404 (at step 452), with possible interest or fees.

Each of the Issuer (j) 404, Merchants (n) 410, Acquirer (i) 406 and the TH 402 may have access to information resources having one or more of the following databases: transaction database (z) 482, merchant database (y) 484, or account database (w) 480. These databases can be connected by a network, internet, virtual private network, or by other means known to those skilled in the art. Moreover, not every participant must necessarily have access to any or all of the databases. Each database can assign read, write, and query permissions as appropriate to the various participants. For example, a Merchant (n) 410 have read access to the account database (w) 480 and the Issuer (j) may have read and write access.

The transaction database (z) 482 is designed to store some or all of the transaction data originating at the Merchants (n) 410 that use a payment device for each transaction conducted between an Account holder (p) 408 and the Merchant (n) 410. The transaction data can include information associated with the account of an Account holder (p) 408, date, time, and location among other more specific information including the amount of the transaction. The database can be searched using account information, date and time (or within proximity thereof), or by any other field stored in the database.

The Merchant database (y) 484 is designed to store information about each Merchant (n) 410. The Merchant database (y) can contain information such as the unique identification of each Merchant (n) 410, an identifier for each point of sale device in use by the Merchant (n) 410, and location of the Merchant (n) 410.

The account database (w) 480 is designed to store account information for payment devices associated with Account holder (p). The account database (w) 480 can store part or all of an account number, unique encryption key, account information, account name. The information from the account database (w) 480 can be associated with information from the transaction database (z) 482.

An Account holder (p) 408 initiates a transaction with a Merchant (n) 410 by presenting a payment device at step 458 to the Merchant (n) 410. The payment device is typically presented at the Point Of Service terminal (POS) at which data thereon is read. Certain transaction information is transmitted from the POS in route to the Merchant's (n) 410 Acquirer (i) 406. The transaction information can include account information, account name, transaction balance, transaction time, transaction date, and transaction location. Sensitive information includes information such account number and account holder name that identify and associate a particular account with a particular account holder. This transaction information may be transmitted via a less secure communication medium. In addition, a transmission of transaction data may occur with weak or no encryption between two or more points from the point of origin, such as the point of sale device at the Merchant (n) 410, and the ultimate destination, such as the Acquirer (i) 406. These points can include, without limitation, from the reader at the POS, the POS at the Merchant (n) 410 and a network router or computer that is connected to a network but is housed and maintained by the Merchant (n) 410 and between the Merchant (n) 410 and the Acquirer (i) 406. The communication channel could be Ethernet, wireless internet, satellite, infrared transmission, or other known communication protocols. Some or all of the transmission may also be stored for record keeping, archival or data mining purposes with little or no encryption. For example, the Merchant (n) 410 may store transaction data, including certain account information in the Merchant's (n) 410 accounts on file database for reuse later.

In this process, transaction information is retrieved from the POS at a Merchant (n) 406. The transaction information is comprised of account information together with other information about the transaction itself: time, date, location, value, etc. Certain of the transaction information is considered sensitive information including, without limitation, account number, credit card verification number, and account name.

In FIG. 4 illustrates a telecommunications network that may make use of any suitable telecommunications network and may involve different hardware, different software and/or different protocols then those discussed below. FIG. 4 is a global telecommunications network that supports purchase and cash transactions using any bankcard, travel and entertainment cards, and other private label and proprietary cards. The network also supports ATM transactions for other networks, transactions using paper checks, transactions using smart cards and transactions using other financial instruments.

These transactions are processed through the network's authorization, clearing and settlement services. Authorization is when an issuer approves or declines a sales transaction before a purchase is finalized or cash is dispersed. Clearing is when a transaction is delivered from an acquirer to an issuer for posting to the customer's account. Settlement is the process of calculating and determining the net financial position of each member for all transactions that are cleared. The actual exchange of funds is a separate process.

Transactions can be authorized, cleared and settled as either a dual message or a single message transaction. A dual message transaction is sent twice—the first time with only information needed for an authorization decision, an again later with additional information for clearing and settlement. A single message transaction is sent once for authorization and contains clearing and settlement information as well. Typically, authorization, clearing and settlement all occur on-line.

FIG. 4 includes one or more transaction handlers 402, access points 430, 432, acquirers 406, and issuers 404. Other entities such as drawee banks and third party authorizing agents may also connect to the network through an access point. An interchange center is a data processing center that may be located anywhere in the world. In one embodiment, there are two in the United States and one each in the United Kingdom and in Japan. Each interchange center houses the computer system that performs the network transaction processing. The interchange center serves as the control point for the telecommunication facilities of the network, which comprise high speed leased lines or satellite connections based on IBM SNA protocol. Preferable, the communication lines that connect an interchange center (Transaction Handler 402) to remote entities use dedicated high-bandwidth telephone circuits or satellite connections based on the IBM SNA-LU0 communication protocol. Messages are sent over these lines using any suitable implementation of the ISO 8583 standard.

Access points 130, 132 are typically made up of small computer systems located at a processing center that interfaces between the center's host computer and the interchange center The access point facilitates the transmission of messages and files between the host and the interchange center supporting the authorization, clearing and settlement of transaction. Telecommunication links between the acquirer (q) and its access point, and between the access point and issuer (i) 104 are typically local links within a center and use a proprietary message format as preferred by the center.

A data processing center (such as is located within an acquirer, issuer, or other entity) houses processing systems that support merchant and business locations and maintains customer data and billing systems. Preferably, each processing center is linked to one or two interchange centers. Processors are connected to the closest interchange, and if the network experiences interruptions, the network automatically routes transactions to a secondary interchange center. Each interchange center is also linked to all of the other interchange centers. This linking enables processing centers to communicate with each other through one or more interchange centers. Also, processing centers can access the networks of other programs through the interchange center. Further, the network ensures that all links have multiple backups. The connection from one point of the network to another is not usually a fixed link; instead, the interchange center chooses the best possible path at the time of any given transmission. Rerouting around any faulty link occurs automatically.

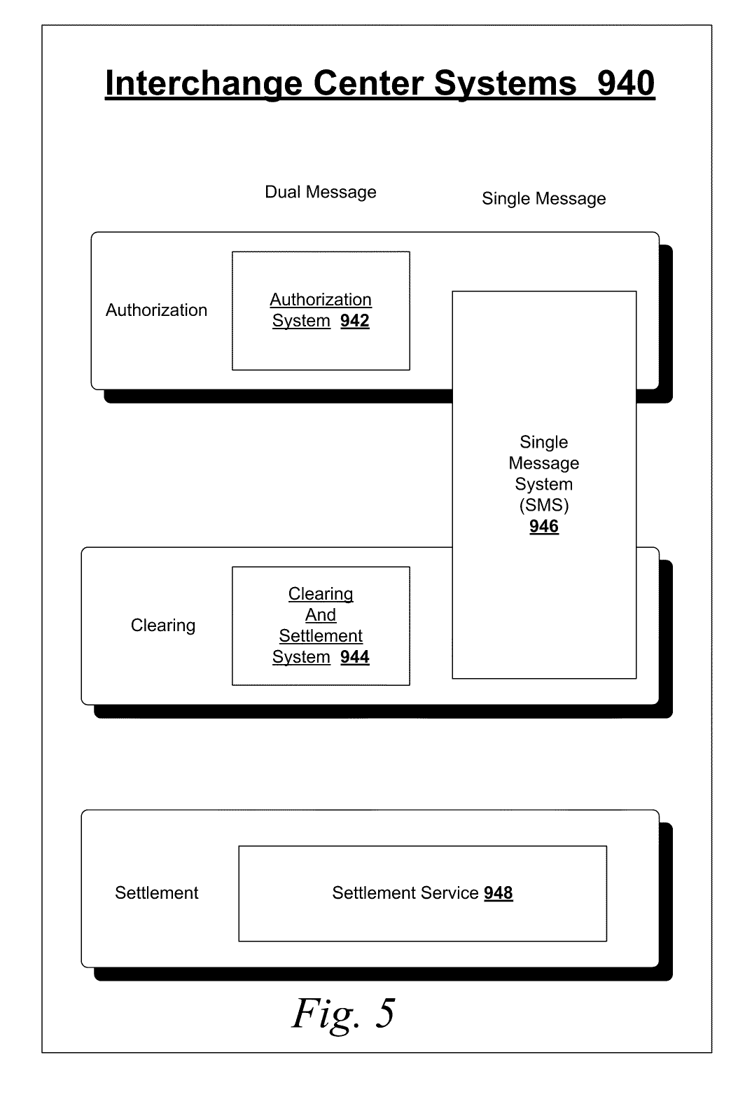

FIG. 5 illustrates systems 940 housed within an interchange center to provide on-line and off-line transaction processing. For dual message transaction, authorization system 942 provides authorization. System 942 supports on-line and off-line functions, and its file includes internal systems tables, a customer database and a merchant central file. The on-line functions of system 942 support dual message authorization processing. This processing involves routing, cardholder and card verification and stand-in processing, and other functions such as file maintenance. Off-line functions including reporting, billing, and generating recovery bulletins. Reporting includes authorization reports, exception file and advice file reports, POS reports and billing reports. A bridge from system 942 to system 946 makes it possible for members using system 942 to communicate with members using system 946 and access the SMS gateways to outside networks.

Clearing and settlement system 944 clears and settles previously authorized dual message transactions. Operating six days a week on a global basis, system 944 collects financial and non-financial information and distributes reports between members It also calculates fees, charges and settlement totals and produces reports to help with reconciliation. A bridge forms an interchange between system 944 processing centers and system 846 processing centers.

Single message system 946 processes full financial transactions. System 946 can also process dual message authorization and clearing transactions, and communicates with system 942 using a bridge and accesses outside networks as required. System 946 processes Visa, Plus Interlink and other card transactions. The SMS files comprise internal system tables that control system access and processing, and the cardholder database, which contains files of cardholder data used for PIN verification and stand-in processing authorization. System 946 on-line functions perform real-time cardholder transaction processing and exception processing for authorization as well as full financial transactions. System 946 also accumulates reconciliation and settlement totals. System 946 off-line functions process settlement and funds transfer requests and provide settlement and activities reporting. Settlement service 948 consolidates the settlement functions of system 944 and 946, including Interlink, into a single service for all products and services. Clearing continues to be performed separately by system 944 and system 946.

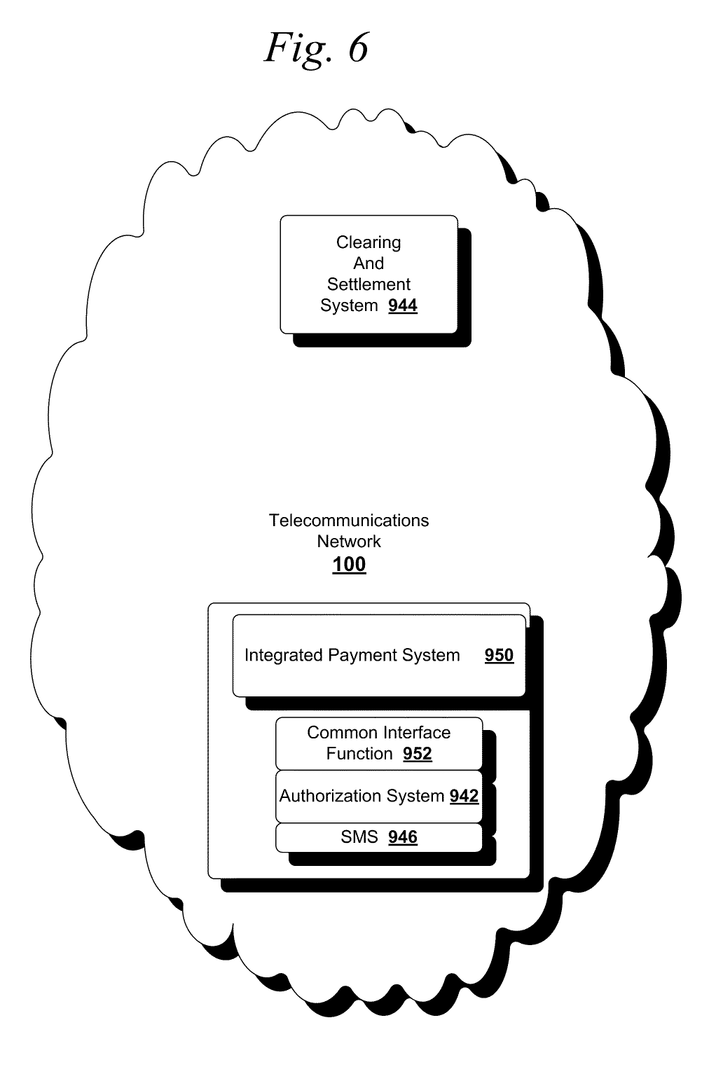

FIG. 6 illustrates another view of components of FIG. 4 as a telecommunications network 100. Integrated payment system 950 is the primary system for processing all on-line authorization and financial request transactions. System 950 reports both dual message and single message processing. In both cases, settlement occurs separately. The three main software components are the common interface function 952, authorization system 942 and single message system 946.

Common interface function 952 determines the processing required for each message received at an interchange center. It chooses the appropriate routing, based on the source of the message (system 942, 944 or 946), the type of processing request and the processing network. This component performs initial message editing, and, when necessary, parses the message and ensures that the content complies with basic message construction rules. Common interface function 952 routes messages to their system 942 or system 946 destinations.

Within the exemplary payment processing systems depicted in FIGS. 1, 3 and 4, and for the exemplary process 200 seen in FIG. 2, exemplary configuration options, and exemplary operational tasks and options, with other implementation details, for the corresponding transaction handler 106, 402 and host 412 are listed in Appendix A, below. The steps of a method, process, or algorithm described in connection with the implementations disclosed herein may be embodied directly in hardware, in a software module executed by a processor, or in a combination of the two. The various steps or acts in a method or process may be performed in the order shown, or may be performed in another order. Additionally, one or more process or method steps may be omitted or one or more process or method steps may be added to the methods and processes. An additional step, block, or action may be added in the beginning, end, or intervening existing elements of the methods and processes.

The above description of the disclosed implementations is provided to enable any person of ordinary skill in the art to make or use the disclosure. Various modifications to these implementations will be readily apparent to those of ordinary skill in the art, and the generic principles defined herein may be applied to other implementations without departing from the spirit or scope of the disclosure. Thus, the disclosure is not intended to be limited to the implementations shown herein but is to be accorded the widest scope consistent with the principles and novel features disclosed herein.

What is claimed is:

1. A method comprising a plurality of steps each being performed by hardware executing software, wherein the steps include:
receiving an electronic message through a single logical point of access in a telecommunications network, wherein:
the received electronic message contains an identifier for an account used to conduct a transaction in a payment processing system;
the received electronic message is received from a logical address associated with a recipient in the payment processing system that is selected from the group consisting of sent from an issuer of the account to the account holder, an acquirer for a merchant with whom the transaction was conducted on the account, the account holder, and a transaction handler who processes the issuer's payment for the transaction for delivery to the acquirer for the merchants; and
the single logical point of access is in communication with each of the issuer, the merchant's acquirer, the account holder, and the transaction handler;
retrieving data, from a database, corresponding to the account used to conduct the transaction in the payment processing system;
and
sending an electronic message from the single logical point of access in the telecommunications network, wherein:
the sent electronic message contains the data retrieved from the database; and
the sent electronic message is sent to a logical address associated with a recipient in the payment processing system that is selected from the group consisting of the issuer of the account to the account holder, the acquirer for the merchant with whom the transaction was conducted on the account, the account holder, and the transaction handler who processes the issuer's payment for the transaction for delivery to the acquirer for the merchant.

2. The method as defined in claim 1, wherein the data retrieved from the database is a report selected from the group consisting of an expense report for the account.

3. A computer readable medium comprising the software which, when executed by the hardware, performs the steps of claim 1.

4. An apparatus comprising:
means for receiving an electronic message through a single logical point of access in a telecommunications network, wherein:
the received electronic message contains an identifier for an account used to conduct a transaction in a payment processing system;
the received electronic message is received from a logical address associated with a recipient in the payment processing system that is selected from the group consisting of sent from an issuer of the account to the account holder, an acquirer for a merchant with whom the transaction was conducted on the account, the account holder, and a transaction handler who processes the issuer's payment for the transaction for delivery to the acquirer for the merchants; and
the single logical point of access is in communication with each of the issuer, the merchant's acquirer, the account holder, and the transaction handler;
means for retrieving data, from a database, corresponding to the account used to conduct the transaction in the payment processing system;
and
means for sending an electronic message from the single logical point of access in the telecommunications network, wherein:
the sent electronic message contains the data retrieved from the database; and
the sent electronic message is sent to a logical address associated with a recipient in the payment processing system that is selected from the group consisting of the issuer of the account to the account holder, the acquirer for the merchant with whom the transaction was conducted on the account, the account holder, and the transaction handler who processes the issuer's payment for the transaction for delivery to the acquirer for the merchant.

5. The method as defined in claim 4, wherein the data retrieved from the database is a report selected from the group consisting of an expense report for the account.

6. The apparatus as defined in claim 4, wherein each of the means for receiving, the means for retrieving data, and the means for sending comprises hardware executing software to perform the function, respectively, of the receiving, of the retrieving data, and of the sending.

7. A computer readable medium comprising
code for receiving an electronic message through a single logical point of access in a telecommunications network, wherein:
the received electronic message contains an identifier for an account used to conduct a transaction in a payment processing system;
the received electronic message is received from a logical address associated with a recipient in the payment processing system that is selected from the group consisting of sent from an issuer of the account to the account holder, an acquirer for a merchant with whom the transaction was conducted on the account, the account holder, and a transaction handler who processes the issuer's payment for the transaction for delivery to the acquirer for the merchants; and
the single logical point of access is in communication with each of the issuer, the merchant's acquirer, the account holder, and the transaction handler;
code for retrieving data, from a database, corresponding to the account used to conduct the transaction in the payment processing system;
and
code for sending an electronic message from the single logical point of access in the telecommunications network, wherein:
the sent electronic message contains the data retrieved from the database; and
the sent electronic message is sent to a logical address associated with a recipient in the payment processing system that is selected from the group consisting of the issuer of the account to the account holder, the acquirer for the merchant with whom the transaction was conducted on the account, the account holder, and the transaction handler who processes the issuer's payment for the transaction for delivery to the acquirer for the merchant.
